(19) United States
(12) Patent Application Publication
(10) Pub. No.: US 2007/0236096 A1
(43) Pub. Date: Oct. 11, 2007

(54) Carbon brush holder device

(76) Inventor: Stefan Dorner, Kaufbeuren (DE)

Correspondence Address: ABELMAN, FRAYNE & SCHWAB, 666 THIRD AVENUE, 10TH FLOOR, NEW YORK, NY, 10017, US

(21) Appl. No.: 11/732,841

(22) Filed: Apr. 4, 2007

(30) Foreign Application Priority Data
Apr. 6, 2006 (DE) 10 2006 000 161.3

(51) Int. Cl. H01R 39/44

(52) U.S. Cl. 310/241

(57) ABSTRACT

A motor (2) includes a carbon brush holder device (16) for reversing the rotating direction of the motor (2) and which has a brush holder (18) which is rotatable relative to the stator (8) of the motor (2) in clockwise running position and counterclockwise running position, two carbon brush guides which electrically connected to the stator (8) in both running positions by a switching arrangement (45) and provided at the brush holder (18), with the switching arrangement (45) having stator-side switching contact means and brush-side switching contact means which produce different contacts in the clockwise running position and the counterclockwise running position for reversing the polarity of the motor (2), and with the switching contact means are being encapsulated relative to the rest of the carbon brush holder device (16).

### BACKGROUND OF THE INVENTION

1. Field of the Invention

The present invention relates to an electric motor with a carbon brush holder device by means of which a rotational direction of the electric motor can be reversed. The carbon brush holder device has a brush holder which is rotatable relative to a stator of the motor in a clockwise running position and a counterclockwise running position. Two carbon brush guides which are electrically connected to a stator winding in both running positions by a switching arrangement are provided at the brush holder. The switching arrangement has switching contact means which produces different contacts in the clockwise running position and the counterclockwise running position. Accordingly, switching between the two running positions simultaneously causes a reversal of the polarity of the motor. The switching arrangement is actuated for this purpose by the brush holder.

2. Description of the Prior Art

Carbon brush holder devices of the type mentioned above make it possible to optimize commutation by the different rotational positions of the brush holder in the clockwise running position and counterclockwise running position. At the same time, a reversal of the polarity of the motor takes place when a change between the two running positions which is effected by altering operation between the switching contact means, takes place.

EP 03 29 249 A1 discloses a carbon brush holder device in which the switching contact means have two contact strips that are fixedly held at the stator housing. They form in each instance two bent ends, one of which engages in one of two chambers of the brush holder in both running positions in order to make electrical contact with a carbon brush guide arranged therein.

Switching contact means formed by contact strips are disadvantageous in that they are arranged openly at the carbon brush holder device and are accordingly exposed to soiling and wear, which can in turn lead to burnt contacts and failure of the equipment in question.

### SUMMARY OF THE INVENTION

It is the object of the present invention to avoid the above-mentioned disadvantages in a carbon brush holder device and to improve the protection of the electric switching contact means.

According to the invention, this object is achieved by encapsulating the switching contact means at least to a great extent, preferably completely, with respect to the carbon brush holder device; that is, they are accommodated in a receptacle that is for the most part closed on all sides relative to the brush holder and relative to the components mounted at the brush holder. This provides a particularly good protection of the switching contact means against soiling and wear.

In an especially preferred embodiment, the switching contact means is received in a switch housing of a switch which can be actuated by the brush holder. In this way, the switching contact means can be closed off in a particularly effective manner from the rest of the carbon brush holder device and from any contamination occurring therein during operation, while at the same time a reliable reversal of polarity of the motor is ensured during the rotation of the brush holder.

In an advantageous manner, the switch has a switching member which can be moved into two switching positions by the brush holder. The required contacts of the switching contact means can be reliably produced for both running positions in this way.

In this connection, it is advantageous when the switch is formed by a commercially available lug switch, and the switching member is formed by its switching lug so that it is possible to produce the carbon brush holder device economically.

The brush holder preferably has an actuating element with which the switching member can be actuated. A particularly reliable and accurate actuation of the switching member and switch can be ensured generally by the actuating element of this kind.

The actuating element is advantageously formed by a handle of the brush holder with which the brush holder can be adjusted between the running positions externally to the equipment in question. A handle of this kind generally projects radially from a base body of the brush holder and, therefore, apart from rotating the brush holder, is also especially suitable for acting upon the switching member with the required switching forces for switching the switch.

Further, it is especially advantageous when electric connections are provided between the brush-side switching contact means and the carbon brush guides by conductors, for example, in the form of wires. In this way, the brush-side switching contact means and, therefore, also the entire switching arrangement can be positioned substantially in any manner desired. At the same time, a reliable electric connection is ensured between the carbon brush guides and carbon brush brushes, respectively, and the brush-side switching contact means.

In a particularly advantageous embodiment form, the switch is held at the stator. In this way, when the switch is securely mounted, the switch can be actuated in a simple manner by the brush holder. Accordingly, when the brush holder rotates relative to the stator, a corresponding movement of the switching member is carried out relative to the rest of the switch, which makes possible an exactly synchronous reversal of the polarity of the motor when switching between the running positions.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1: a side view of a motor with a carbon brush holder device according to the invention;

FIG. 2: a top view of the carbon brush holder device in direction II referring to FIG. 1; and

FIG. 3: a top view, considered in direction III in FIG. 1, of a switch of the carbon brush holder device without the motor.

### DETAILED DESCRIPTION OF THE PREFERRED EMBODIMENT:

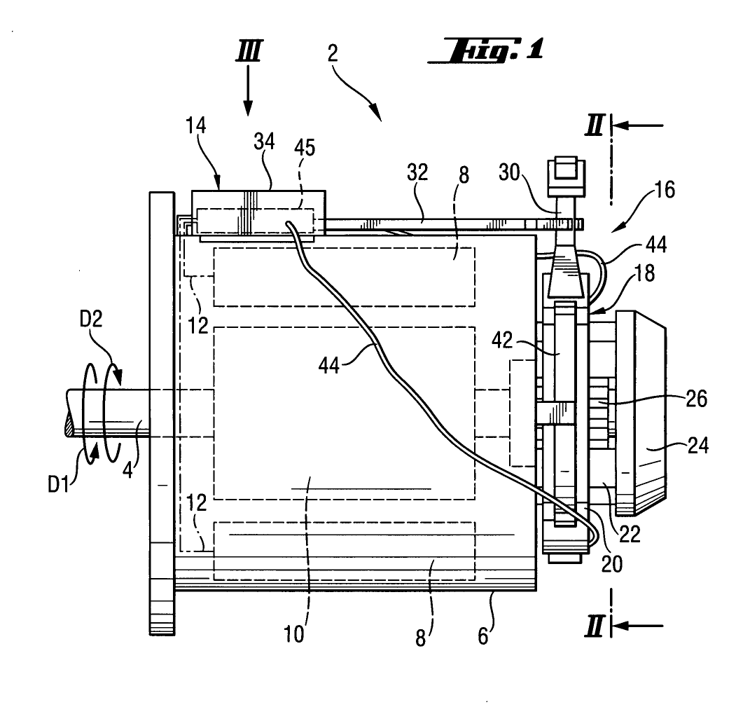

FIG. 1 shows a motor 2 in the form of a universal motor for a hand-held electric power tool which drives a tool holder, not shown, in a first rotating direction D1 or a second rotating direction D2 by means of a motor shaft 4. The motor 2 has a stator 8 and a rotor 10 both located in a stator housing 6. A stator winding, not shown in more detail, is connected by two electric stator connections 12 to a switch 14 in the form of a commercially available lug switch that is fastened to the stator housing 6.

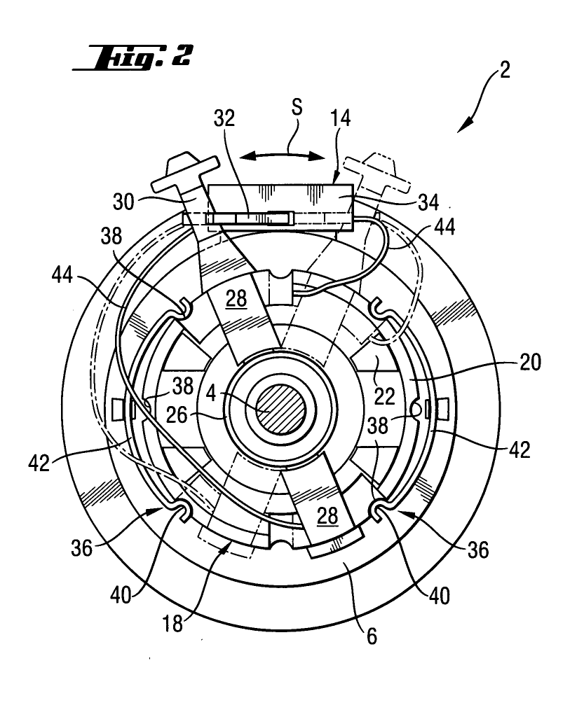

A carbon brush holder device, designated in its entirety by 16, is provided at one end of the stator housing 6. This carbon brush holder device has a brush holder 18 with an annular base body 20 which is held so as to be rotatable in a rotational direction S (see FIG. 2) on bearing pins 22 which are fixed with respect to the housing and which support a bearing block 24. The bearing block 24 serves to support the motor shaft 4 at one end at which a commutator 26 of the motor 2 is arranged.

As can be seen particularly from FIG. 2, the brush holder 18 has two carbon brush guides 28 for receiving and guiding carbon brush brushes, not shown in more detail, and a handle 30 which projects radially from the base body 20. This handle 30 serves to displace the brush holder 18 in rotational direction S between a clockwise running position shown in FIG. 2 and a counterclockwise running position which is indicated by dash-dot lines. The handle 30 can be actuated from outside a device housing, not shown.

The handle 30 serves at the same time as an actuating element for the switch 14. For this purpose, the handle 30 is coupled with a switching member 32 of the switch 14 and which is formed by a switch lug. The switching member 32 projects from a switch housing 34 of the switch 14 and partially engages around the handle 30. Alternatively, the handle 30 can also have a receptacle for the switching member 32. In this case, the switching member 32 is coupled with the handle 30 and, by rotational the latter, can be moved into two switching positions corresponding to the clockwise running position and the counterclockwise running position of the brush holder 18.

Further, locking means, designated in their entirety by 36, is provided between the stator housing 6 and the brush holder 18. The locking means 36 reliably holds the carbon brush guides 28 in the respective selected running position that is predetermined in such a way that an optimal commutation is achieved in the clockwise running position and counterclockwise running position. For this purpose, the locking means 36 has, for example, a plurality of recesses 38 which are incorporated in the brush holder 18 and which cooperate in both the counterclockwise running position and the clockwise running position with correspondingly positioned locking catches 40 of two spring elements 42 which are held at the stator housing 6.

When the brush holder 18 is fixed in one of the two running positions, one of the two switching positions of the switching member 32 and switch 14, respectively, is also secured at the same time.

It can also be seen that the switch 14 is electrically connected to the carbon brush guides 28 in each instance by an electric wire conductor 44 so that the switch 14 can be positioned virtually anywhere in relation to the brush holder 18.

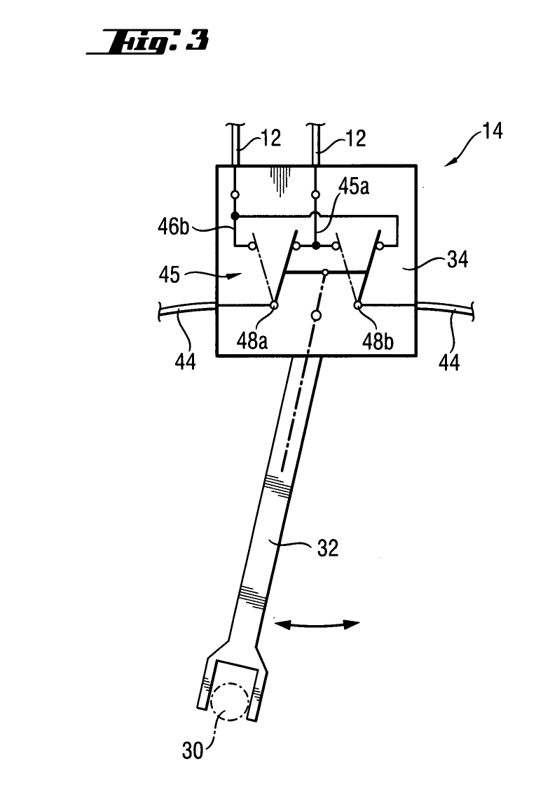

The operation of the switch 14 is illustrated with reference to FIG. 3. As can be seen from this drawing, a switching arrangement 45, shown schematically, is received in the switch housing 34 so as to be almost completely enclosed relative to the outside. The switch housing 34 has recesses (not shown) only in the areas in which the electric stator connections 12, the conductors 44, and the switching member 32 enter and exit, respectively. Appropriate structural steps or additional sealing means can be provided at these recesses to improve the sealing of the switch housing 34 from the outside.

The switching arrangement 45 has first stator-side switching contact means 46a and second stator-side switching contact means 46b which are connected to the electric stator connections 12, and first brush-side switching contact means 48a and second brush-side switching contact means 48b which are connected to the conductors 44. In the switching position shown in the drawing, which corresponds to the clockwise running position of the brush holder 18, the first stator-side switching contact means 46a is connected to the first brush-side switching contact means 48a, and the second stator-side switching contact means 46b is connected to the second brush-side switching contact means 48b.

In the switching position shown with dash-dot lines and corresponding to the counterclockwise running position of the brush holder 18, the first stator-side switching contact means 46a is connected to the second brush-side switching contact means 48b, and the second stator-side switching contact means 46b is connected to the first brush-side switching contact means 48a.

This different commutation in the two switching positions results in a reversal of polarity of the motor and, therefore, in a respective change in the rotational direction of the motor when the brush holder 18 is pivoted between the two running positions.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. An electric motor (2), comprising a stator (8); and a carbon brush holder (16) for reversing a rotational-direction of the motor (2) and including a brush holder (18) rotatable relative to the stator (8) in clockwise running position and counterclockwise running position, two carbon brush guides (28) provided at the brush holder (18), and a switching arrangement (45) for electrically connecting the two carbon brush guides to the stator (8) in the clockwise and counterclockwise running positions, the switching arrangement (45) being adjustable by the brush holder (18) and having stator-side switching contact means (46a, 46b) and brush-side switching contact means (48a, 48b) which produce different contacts in the clockwise running position and the counterclockwise running position for reversing polarity of the motor (2), the switching contact means (46a, 46b; 48a, 48b) being encapsulated relative to the carbon brush holder device (16).

2. A motor according to claim 1, further comprising a switch (14) actuatable by the brush holder (18) and having a housing (34) in which the switching means (46a, 46b; 48a, 48b) is received.

3. A motor according to claim 2, wherein the switch (14) has a switching member (32) movable into two switching positions by the brush holder (18).

4. A motor according to claim 3, wherein the switch (14) is formed as a lug switch, and the switching member (32) is formed by the switching lug.

5. A motor according to claim 3, wherein the brush holder (18) has an actuation element for actuating the switching member (32).

6. A motor according to claim 5, wherein the actuation element is formed by a handle (30) of the brush holder (18) with which the brush holder (18) can be adjusted between the running positions.

7. A motor according to claim 1, wherein electric connections are provided between the brush-side switching contact means (48a, 48b) and the carbon brush guides (28) by conductors (44).

8. A motor according to claim 2, wherein the switch (14) is held at the stator (8).
